(19) United States
(12) Patent Application Publication
(10) Pub. No.: US 2013/0110542 A1
(43) Pub. Date: May 2, 2013

(54) PATIENT DATA MANAGEMENT

(71) Applicants: Jayaram R. Iyer, Seattle, WA (US); Benjamin L. Chronister, Oakton, VA (US); Jay W. Daugherty, Arlington, VA (US); David R. Stelts, JR., Oakton, VA (US); Peter G. Burns, Seattle, WA (US); Bryan Dove, Seattle, WA (US); Kishore R. Chaliparambil, Snoqualmie, WA (US); Mahmood G. Qadir, Redmond, WA (US); Mehul Y. Shah, Redmond, WA (US)

(72) Inventors: Jayaram R. Iyer, Seattle, WA (US); Benjamin L. Chronister, Oakton, VA (US); Jay W. Daugherty, Arlington, VA (US); David R. Stelts, JR., Oakton, VA (US); Peter G. Burns, Seattle, WA (US); Bryan Dove, Seattle, WA (US); Kishore R. Chaliparambil, Snoqualmie, WA (US); Mahmood G. Qadir, Redmond, WA (US); Mehul Y. Shah, Redmond, WA (US)

(73) Assignee: MICROSOFT CORPORATION, Redmond, WA (US)

(21) Appl. No.: 13/284,702

(22) Filed: Oct. 28, 2011

(51) Int. Cl. G06Q 50/24

(52) U.S. Cl. 705/3

(57) ABSTRACT

This patent relates to patient data and more specifically to accessing and managing patient data. One example can generate a user interface from which a user can select predefined entities for use by a health care management application, wherein the entities abstract the health care management application from underlying patient data. This example can allow the user to select an individual predefined entity from the list or define a different entity on the user interface. This example can also enable the user to associate the individual entity or the different entity with a semantic tag.

### BACKGROUND

In the medical setting, health care organizations are struggling with handling large amounts of patient data in a meaningful way. Database technologies exist for storing this patient data. However, interacting with the patient data is very difficult and cumbersome. For instance, applications that interact with the patient data have to be custom built to interact with a particular database instantiation. That is, with existing technologies, the application developer has to understand the nuances of the database for which he/she is writing the application and directly tie the application to the data. Stated another way, the interfaces an application could use to connect to the database require the application to be directly tied to the underlying database. Further, querying the database, such as by an end user clinician, requires a thorough understanding of how the database is set up; a skill set that most clinicians have neither the desire nor time to obtain.

### SUMMARY

This discussion relates to patient data and more specifically to accessing and managing patient data. One implementation can generate a user interface from which a user can select predefined entities for use by a health care management application. The entities abstract the health care management application from underlying patient data. This implementation can allow the user to select an individual predefined entity from the list or define a different entity on the user interface. This implementation can also enable the user to associate the individual entity or the different entity with a semantic tag.

Another implementation can access an entity registry that lists entities used by applications installed on a health care management platform operating on behalf of a health care organization. This implementation can identify any unbound entities in the entity registry. This implementation can also present individual unbound entities for binding to patient data of the health care organization.

A further implementation can store rules relating to entities of a patient data abstraction framework. This implementation can suggest queries based upon the rules. It can also receive a value input from the user. The implementation can generate an individual query from the suggested queries that includes the user provided value input. It can search patient data accessible to the abstraction framework with the query. This implementation can also cause query results to be presented to the user.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 shows an example scenario for implementing patient data management in accordance with some implementations of the present concepts.

FIG. 2 shows an example logical layer architecture for implementing patient data management in accordance with some implementations of the present concepts.

FIGS. 3-20 show user interface screenshot examples in accordance with some implementations of the present concepts.

FIG. 21 is an example of a system upon which patient data management can be implemented in accordance with some implementations of the present concepts.

FIGS. 22-24 illustrate examples of flowcharts of secure patient data management methods in accordance with some implementations of the present concepts.

### DETAILED DESCRIPTION

### Overview

This patent relates to patient data and more specifically to accessing and managing patient data. This is an issue of great concern to health care organizations. A health care organization can be any type of health care related organization from a sole provider doctor's office to a nationwide chain of hospitals and clinics. Database schemas at health care organizations can be complex. Further, each health care organization can have its own way of organizing patient data. Traditionally, in order to search the database, users need to learn the internals of the schema. Clinical concepts (e.g. whether a patient is diabetic) are often defined based on several disparate data points, and these data points can change over time. To further complicate matters, each health care organization may define such concepts differently. Users, such as clinicians, want to be able to use these concepts to search but do not want to be burdened or exposed to all the internals of the database minutiae.

The present inventive concepts can provide a patient data abstraction framework (PDA). The patient data abstraction framework can abstract the end-users from the internals (e.g., minutiae) of the database schema and can enable the end-users to search the database in a manner that is more natural to their everyday language. For instance, an end-user may enter a query as “show me all patients who are on beta blockers and diuretics” without knowing what is going on ‘under the hood’.

From an application developer perspective, the patient data abstraction framework can create reusable pieces of clinical logic that can be used to define clinical concepts without requiring the development of custom code.

### Example Scenarios

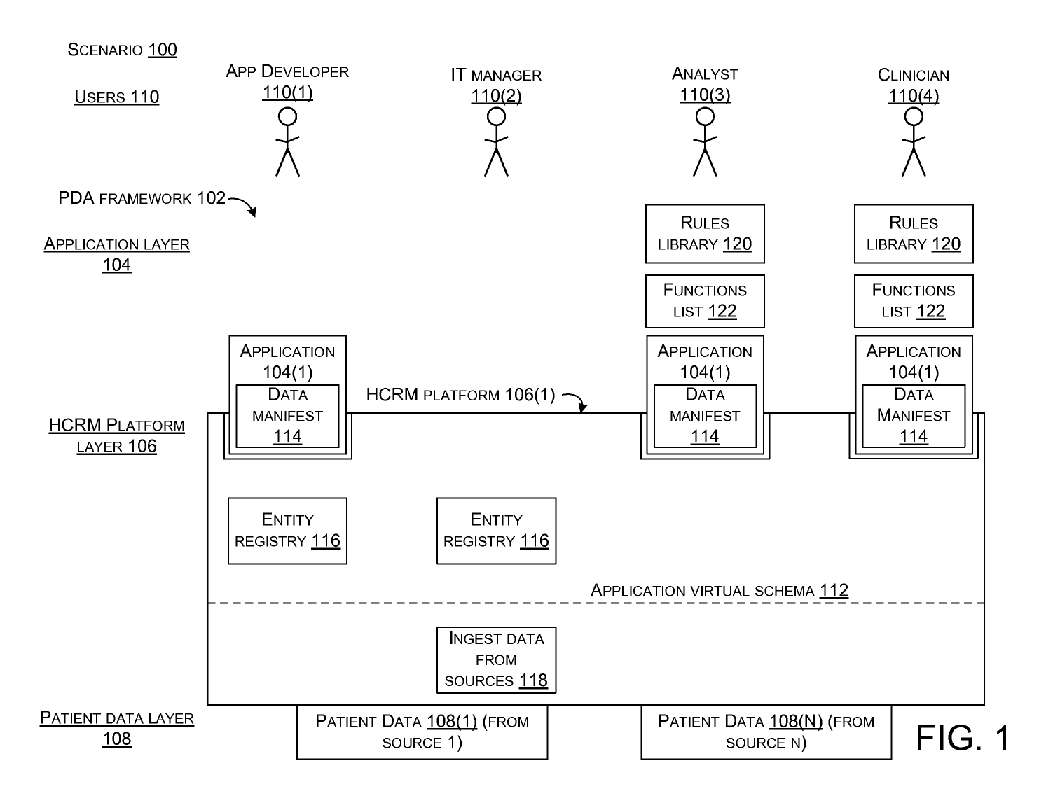

The discussion above broadly introduces inventive patient data management and access concepts. To aid the reader in understanding these inventive concepts, FIG. 1 illustrates scenario 100 that provides a context in which the patient data management concepts can be applied via a patient data abstraction (PDA) framework. Scenario 100 represents the patient data abstraction framework at three levels or horizontal layers: an application layer 104; a health care record management (HCRM) platform layer 106; and a patient data layer 108. Assume for purposes of explanation that scenario 100 relates to a single health care organization that obtained patient data 108(1) from one source and patient data 108(N) from another source. Note that each source and/or health care organization may store their patient data in a non-standardized manner. Thus, a data table from one health care organization not only may include different patients than a data table for another health care organization, but the data tables themselves may be organized differently. The present concepts recognize and address these differences without relying on the application developer to appreciate them. While the present patient data abstraction framework can be explained relative to a single health care organization, the applicability of the present patient data abstraction framework to other health care organizations should become apparent from the description that follows.

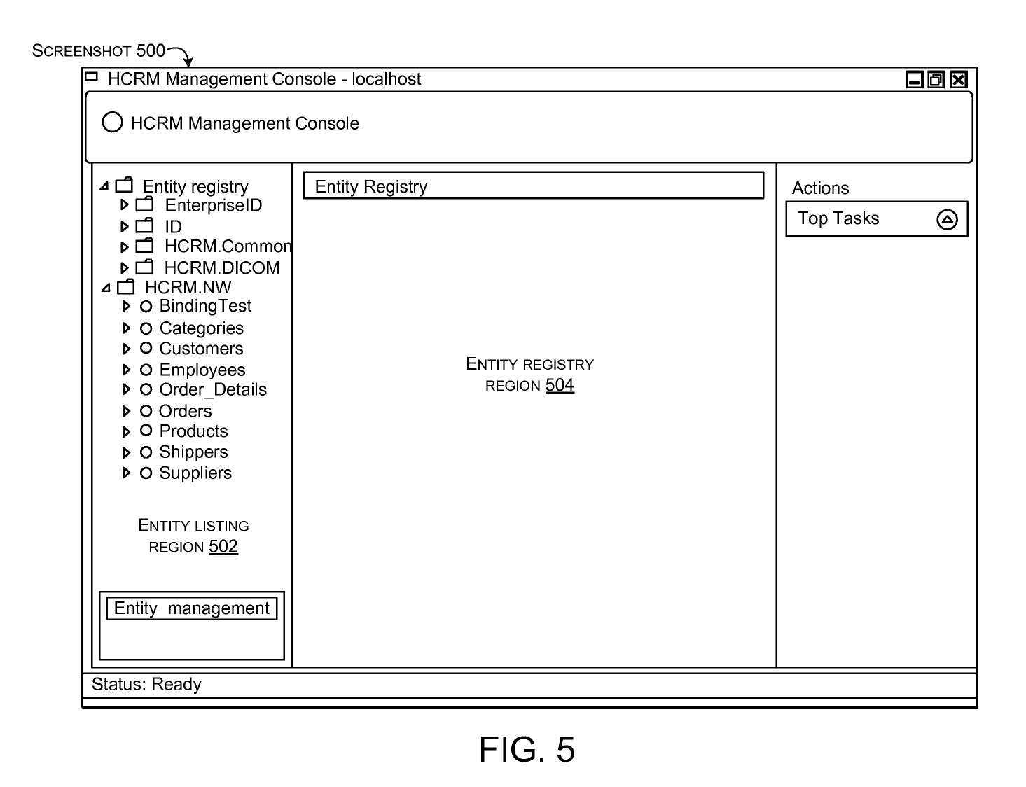

For purposes of explanation, the present inventive concepts are explained from the perspective of features offered to various users 110. As such, each user experience is represented vertically through the layers. The illustrated users include an application developer 110(1), an information technology (IT) manager 110(2), an analyst 110(3), and a clinician 110(4). User experiences are introduced in the discussion here and will be discussed in more detail below relative to subsequent FIGS. 5-20. The illustrated and discussed user experiences are provided for purposes of explaining the underlying patient data abstraction framework. Of course, the underlying patient data abstraction framework can support other users and not all of the features of the underlying patient data abstraction framework are described for sake of brevity.

Starting with the user experience of the application developer 110(1), the HCRM platform 106(1) can allow the application developer to write an application 104(1) without understanding the nuances (e.g., database organizational structure) of the underlying patient data 108(1)-108(N). More specifically, the HCRM platform 106(1) can provide an application virtual schema 112 that enables the application to access the appropriate underlying patient data 108(1)-108(N). For example, the application developer 110(1) can write the application to accomplish a desired functionality relating to the patient data. The application developer can then create a data manifest 114 that accompanies the application. The data manifest 114 can define entities utilized by the application 104(1). The entities can be thought of as data objects that relate to patient data. The developer can also semantically tag each entity on the data manifest. The semantic tag can be thought of a commonly understood meaning for the entity. The data manifest 114 can be entered into an entity registry 116 of the HCRM platform 106(1).

In summary, the HCRM platform 106(1) can allow the application developer 110(1) to deploy the same application 104(1) to multiple health care organizations since the application developer is now freed from tying the application 104(1) directly to the patient data 108(1) and 108(N) of a given organization.

The IT manager 110(2) can access the entity registry 116 and review the entities from the application 104(1). The IT manager 110(2) likely understands the organization of patient data 108(1) and 108(N) and can bind the entities from the application 104(1) to the underlying patient data. Once bound, at 118, the HCRM platform 106(1) can ingest the patient data utilized by the application 104(1) from the various sources of patient data 108(1) and 108(N).

Stated another way, the application virtual schema 112 can simplify the application development process and make applications portable and easy to deploy. The application virtual schema can allow application developers to define their conceptual data model that describes the things of significance to an application and deploy the application into the HCRM platform 106(1). The virtual schema objects and their attributes can be semantically annotated using ontology elements. Similarly, patient data 108(1) and 108(N) can also be semantically annotated using ontology elements during ingestion. This approach enables the lookup and binding of the virtual schema objects to the physical schema objects during application deployment time.

The analyst 110(3) can define rules using entities from the entity registry 116. The analyst then puts the defined rules in a rules library 120. The analyst can also create functions from multiple rules. The functions can be placed in a functions list 122.

The clinician 110(4) can utilize the rules defined by the analyst in the rules library to query the patient data 108(1) and 108(N) without knowing anything about how the patient data is organized or knowing anything about database structure, etc.

Stated another way, users, such as the IT manager 110(2) and/or the analyst 110(3) can create and publish re-usable units of logic (e.g., rules and/or functions) that leverage individual entities and semantically interoperable constructs that serve as a basis for queries that may be utilized by the clinician. In turn, the clinician 110(4) can consume the rules by providing semantic inputs without the user knowing details of underlying physical or logical layers of the patient data abstraction framework.

Now, consider an explanation based upon the supposition that a purpose of a health care management system is patient care. Patient care can be enhanced by being able to identify patients from the patient data that meet some criteria. For instance, the clinician 110(4) has a clinical desire to view a list of patients who meet a set of criteria. The clinician understands what those criteria are in terms of the clinical concepts that are involved and what their relevance is. However, the clinician tends to have little or no understanding of the data model at their health care organization or how those clinical concepts are expressed in terms of the data model.

The analyst 110(3) understands the organization's data model and how to define more complex clinical concepts from it. However, analysts usually are not clinicians, so they may not understand the relevance of those concepts in clinical situations. The analyst may also lack the skill set of the IT manager 110(2) so the analyst may not understand the technical details of the database schema and how data is populated in the virtual schema.

The IT manager's job is to know all about how data is stored on the disk and how it is served up to the application. However, the IT manager 110(2) does not necessarily have a clinical background or interaction with clinical users, so the IT manager likely does not have a deep understanding of what the patient data they're serving up means to a clinician.

Since no single player necessarily understands all of the parts involved in creating a list of patients based on complex clinical concepts, all of them do their parts. The first step is for the IT manager 110(2) to link up the raw patient data 108(1)-108(N) in the database to the entity model contained in the entity registry. The second step is for an analyst 110(3) to use the patient data stored in the entity model to derive a rule determining if a patient meets a set of criteria. Finally, the clinician 110(4) combines rules together to create a list of patients that meets a clinical need.

### Example Logical Layer Architecture

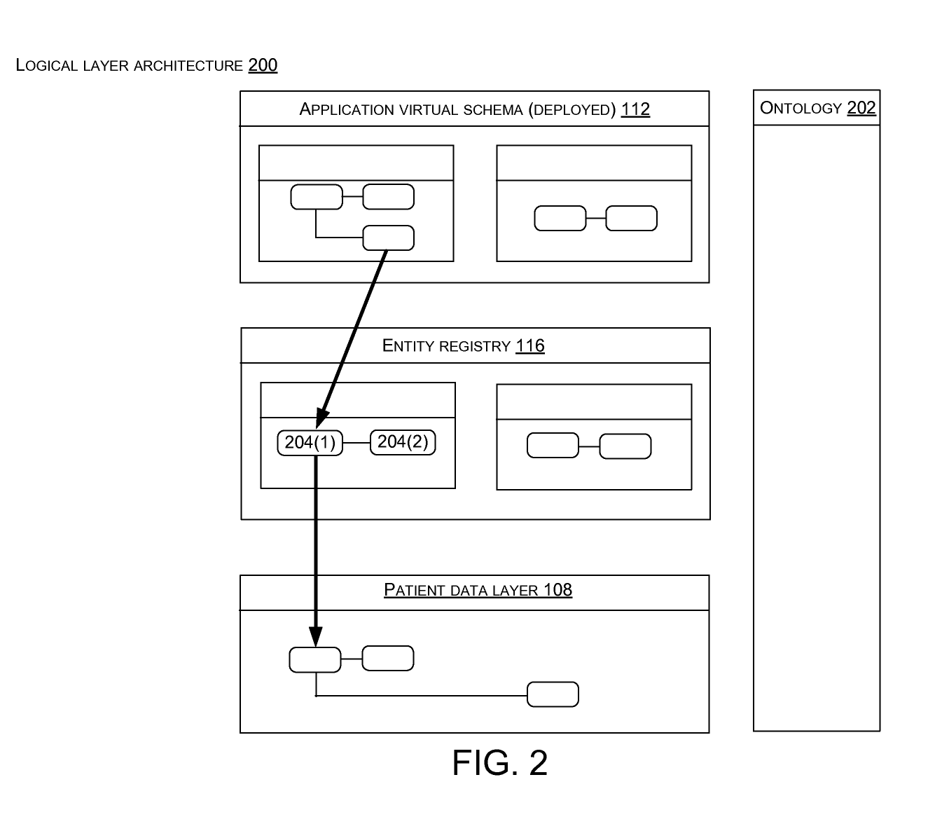

FIG. 2 illustrates logical layer architecture 200 that supports the inventive concepts introduced above. As illustrated in FIG. 2, logical layer architecture 200 includes the patient data layer 108, entity registry 116, and application virtual schema 112. Logical layer architecture 200 also introduces ontology 202. The ontology is illustrated to recognize that semantic labels or tags can be utilized by the various layers when referring to specific elements. The semantic tags can have agreed upon definitions that are utilized in communications between the various layers and thus the layers can be freed from dealing with the database nuances.

In logical layer architecture 200, patient data layer 108 is shown as the bottom layer. Recall that the patient data layer is organization specific and thus tends to be non-standardized from organization to organization. For example, one organization may record their patient temperatures in Celsius, while another records their patient temperatures in Fahrenheit. The patient data layer can be thought of as a data store that contains parsed data from source patient data 108(1) and 108(N). The logical layer architecture 200 may have further layers or sub-layers below the patient data layer 108. For instance, for each source there can be a message archive layer and a shredded layer that has one set of a table per source. At the patient data layer 108, the data can be arranged in tables. The tables and columns of the tables can be semantically tagged using ontology elements as represented generically by ontology 202.

Above the patient data layer 108 is the entity registry 116. The entity registry can be thought of as a dictionary where the published entities and their associations are stored and managed. An entity can be thought of as an object that groups ontology elements (concepts) into meaningful structures (for e.g. Patient, LabResults, etc.). The entities can be uniquely identified using a primary key.

In some implementations, entities can be grouped together in containers that are uniquely identified by a namespace. For instance, one container 204(1) can be included with the HCRM platform 106(1) (FIG. 1), while a second container 204(2) can be specific to the health care organization which employs the HCRM platform 106(1). The entities published in the entity registry 116 for a specific health care organization (e.g., in second container 204(2)) can be visible to all application instances that get installed at that health care organization. An entity in the entity registry can be uniquely identified using a fully qualified name and its version number.

In some implementations, a clean installation of HCRM platform 106(1) may not include any specific schema for the patient data in the patient data layer 108. Alternatively, such implementations could include a “starter kit” (completely separate from the platform) that comes with a pre-defined schema for patient data (such as Lab Results, ADT, etc.) along with semantic tags to annotate the patient data at the patient data layer. This starter kit could contain mapping between the out-of-box entities and the patient data layer that comes with the “starter kit”. Further, the entity registry may include a dictionary of semantic tags that lists the tags and their accepted meanings.

The application virtual schema 112 can be thought of as a map of concepts and their relationships to describe the data model of an application (e.g., application 104(1) of FIG. 1). Specifically, application virtual schema 112 can describe the things of significance to an application, about which the application virtual schema is inclined to collect information, and characteristics of (properties) and associations between pairs of those things of significance (relationships).

As mentioned above, an application can describe its data model using a data manifest (FIG. 1). In some implementations, the data manifest can be materialized as an XML document that contains a collection of object definitions and relationships. The properties of these objects can be semantically annotated with ontology elements and the properties can have a primary key. When the data manifest is deployed at a health care organization, the information available in the data manifest can be used to generate the bindings and other runtime artifacts for the application instance in the patient data.

For purposes of explanation consider the following example that relates to the concepts described above relative to FIGS. 1-2.

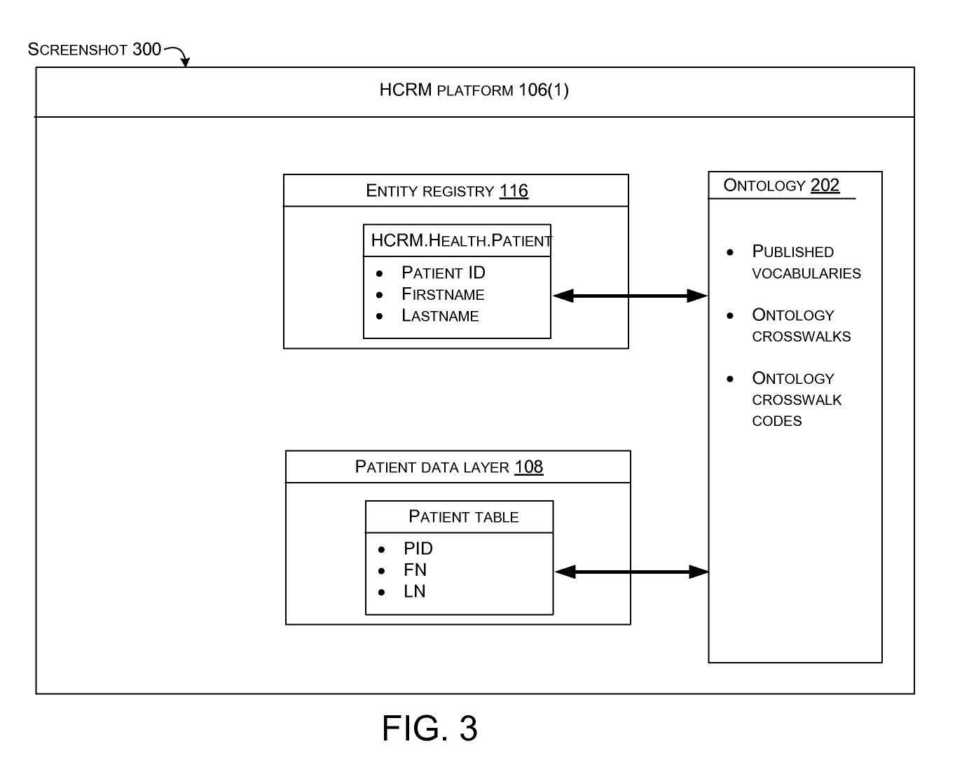

Assumptions:
1. Patient data consists of only one table called [PatientTable] with three columns [PID], [FN] and [LN]. Here the PID column is the patient's id. The columns may be semantically tagged using ontology elements from one or more standard ontologies. Tagging at the patient data layer is not mandatory.
2. The entity registry consists of only one entity called [HCRM.Health.Patient] with three attributes [PatientID], [Firstname] and [Lastname]. The entity attributes will be semantically tagged with ontology elements from one or more standard ontologies.
3. The application's virtual schema consists of one data object called [PatientObject]. The application developer creates this data object from a [HCRM.Health.Patient] entity. As a result, [PatientObject] has the same attributes and semantic annotations as the [HCRM.Health.Patient] entity.
4. Further assume that the HCRM platform installation does not have any deployed applications. FIG. 3 shows an HCRM platform screenshot before the sample application's virtual schema definition (data manifest) is deployed.

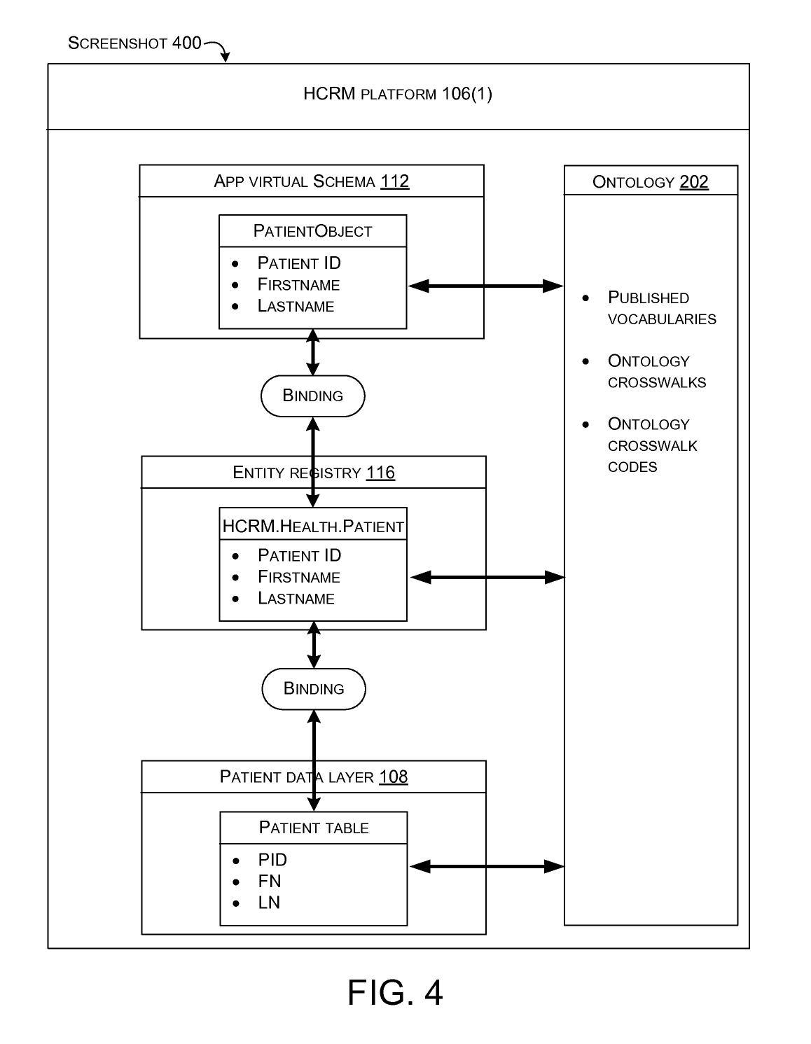

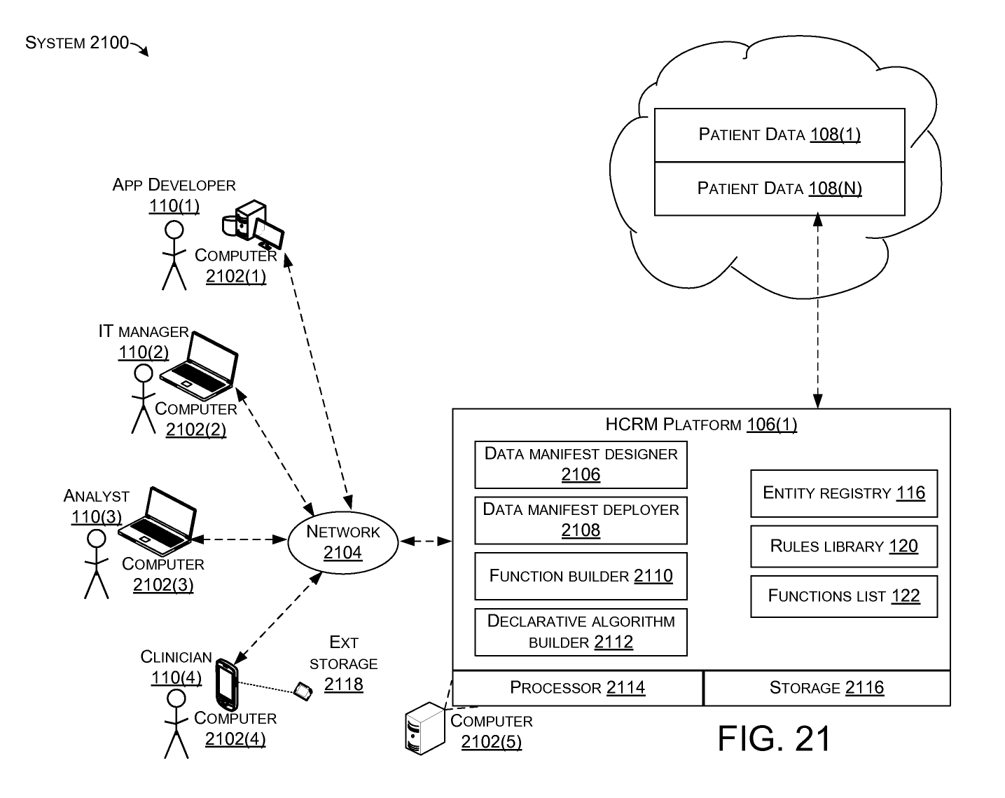

FIG. 4 shows a subsequent screenshot 400. Here, the application's data manifest can be deployed into the HCRM platform 106(1) using a data manifest deployer (shown FIG. 21). At this point various artifacts will be generated and stored in a metadata repository of the application virtual schema 112 for the deployed application instance. The deployed objects and relationships allow the application instance's virtual schema to be bound to the HCRM platform.

In some implementations, the application virtual schema 112 is created per application instance and is not shared across instances. The application virtual schema for this example consists of:
1. The applications virtual schema definition (data manifest). After deployment, the application instance's virtual schema definition will be stored in a more normalized form for improving runtime performance of queries.
2. The mapping between the attributes of the [PatientObject] to the [HCRM.Health.Patient] entity (stored as XML document).
3. A query that defines the application's virtual schema object, [PatientObject], in terms of the [HCRM.Health.Patient] entity (“Virtual Schema Object Query w.r.t HCRM Entities”).

PatientObject =

SELECT
[PatientID] as PatientID,
[Firstname] as Firstname,
[Lastname] as Lastname
FROM [HCRM.Health.Patient]

4. The mapping between the attributes of the [HCRM.Health.Patient] entity to the [PatientTable] columns (stored as XML document).
5. A query that defines the HCRM entity from the entity registry, [HCRM.Health.Patient], in terms of the patient data layer [PatientTable]. (“HCRM Entity Query w.r.t patient data layer Objects”). Note that this does not contain any ACF (Access Control Framework) filter. ACF rules get applied at runtime based on the context of the user executing the query HCRM.Health. Patient=
SELECT
[PID] as PatientID,
[FN] as Firstname,
[LN] as Lastname
FROM [PatientTable]

Note that #4 and #5 can be created and stored per application instance because such a configuration provides application isolation and also enables adding the capability to materialize the application virtual schema per application instance. This configuration also insulates against changes between application instances. So, when any application instance goes through an upgrade or uninstall there is no concern about any other application instance getting affected.

The following example explains how these artifacts can be used at runtime by the HCRM platform.
1. The application business logic uses a HCRM platform provider to execute queries against its virtual schema data objects. The application provides a connection string that identifies the application instance deployed in the HCRM platform. Assume that the query specified by the application is as below (“App Query w.r.t Virtual Schema Objects”).

```
SELECT
  PatientID,
  Firstname,
  Lastname
FROM [PatientObject]
```

2. The HCRM platform service uses the information in the connection string to lookup the application's application virtual schema artifacts. The HCRM platform service reads the query that defines the [PatientObject] in terms of the [HCRM.Health.Patient] entity (“Virtual Schema Object Query w.r.t HCRM Entities”).

```
SELECT
[PatientID] as PatientID,
  [Firstname] as Firstname,
  [Lastname] as Lastname
FROM [HCRM.Health.Patient]
```

3. Next, the HCRM platform service will check if the current user has authorization to execute queries against the [HCRM.Health.Patient] entity referenced in this query. If not, the HCRM platform service will throw an access denied exception.
4. Once authorization check is complete, the HCRM platform service will call the ACF (Access Control Framework) component and send the defining query from Step #2 to ensure that the appropriate ACF filters are added to the query. The ACF allows restricting access to certain attributes (columns) and rows for entities defined in the HCRM entity registry based on the user who is attempting to execute the query and retrieve the patient data. In this case, for purposes of explanation assume that the ACF is configured to
   Prevent access to the [HCRM.Health.Patient.LastName] and
   Allow access to only those patients where [HCRM.Health.Patient.PatientID] is 1, 2 or 3.
5. The ACF component will re-write the original query and generate a new query as shown below. Note that the [Lastname] is set to NULL and a WHERE clause is added (“HCRM Entity Query with ACF rules”).

```
  SELECT
    [PatientID] as PatientID,
    [Firstname] as Firstname,
  NULL as Lastname
FROM [Microsoft.Health.Patient]
  WHERE PatientID IN (1,2,3)
```

6. The [PatientObject] reference in the query shown in “Step 1” will be replaced with the query returned by ACF in Step 5. The expanded query will look as shown below (“App Query w.r.t Virtual Schema Objects with ACF rules”).

```
SELECT
  PatientID,
  Firstname,
  Lastname
FROM
    ( SELECT
            [PatientID] as PatientID,
            [Firstname] as Firstname,
            NULL as Lastname
    FROM [HCRM.Health.Patient]
    WHERE PatientID IN (1,2,3)
    ) as x
) as [PatientObject]
```

7. Finally, the references to the [HCRM.Health.Patient] entity will be replaced with the query that defines the [HCRM.Health.Patient]’ in terms of patient data layer [PatientTable] object. The final fully resolved query will look like shown below—secure and ready for execution on the patient data layer data store (“Fully Resolved Application query”).

```
SELECT
  PatientID,
  Firstname,
  Lastname
FROM
  ( SELECT
          [PatientID] as PatientID,
          [Firstname] as Firstname,
          NULL as Lastname
      FROM (
          SELECT
              [PID] as PatientID,
              [FN] as Firstname,
              [LN] as Lastname
              FROM [PatientTable]
          ) as y
  WHERE PatientID IN (1,2,3)
      ) as x
) as [PatientObject]
```

8. The HCRM platform Service internally uses a provider such as SQL ADO.NET to execute the final query. The provider can include a library that implements interfaces and allows applications to execute queries on top of application virtual schema objects. In summary, the provider exposes the application virtual schema data objects like tables to the application. The provider can then audit the data in the result set and return the results to the caller (e.g., the application).

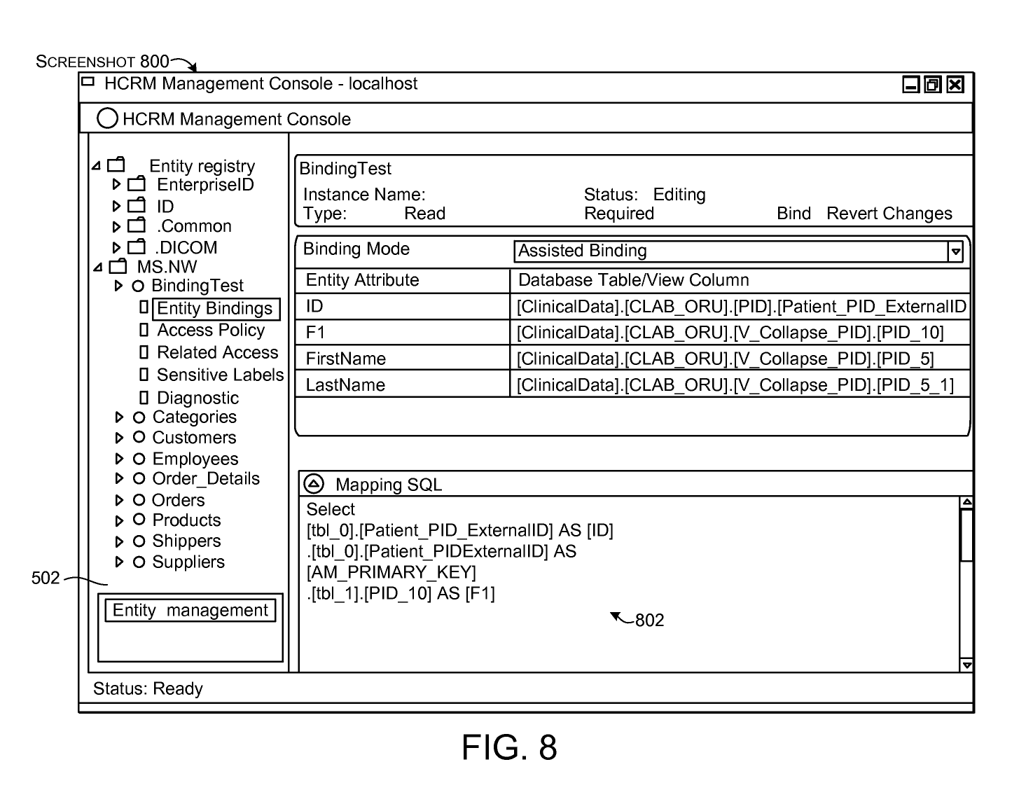

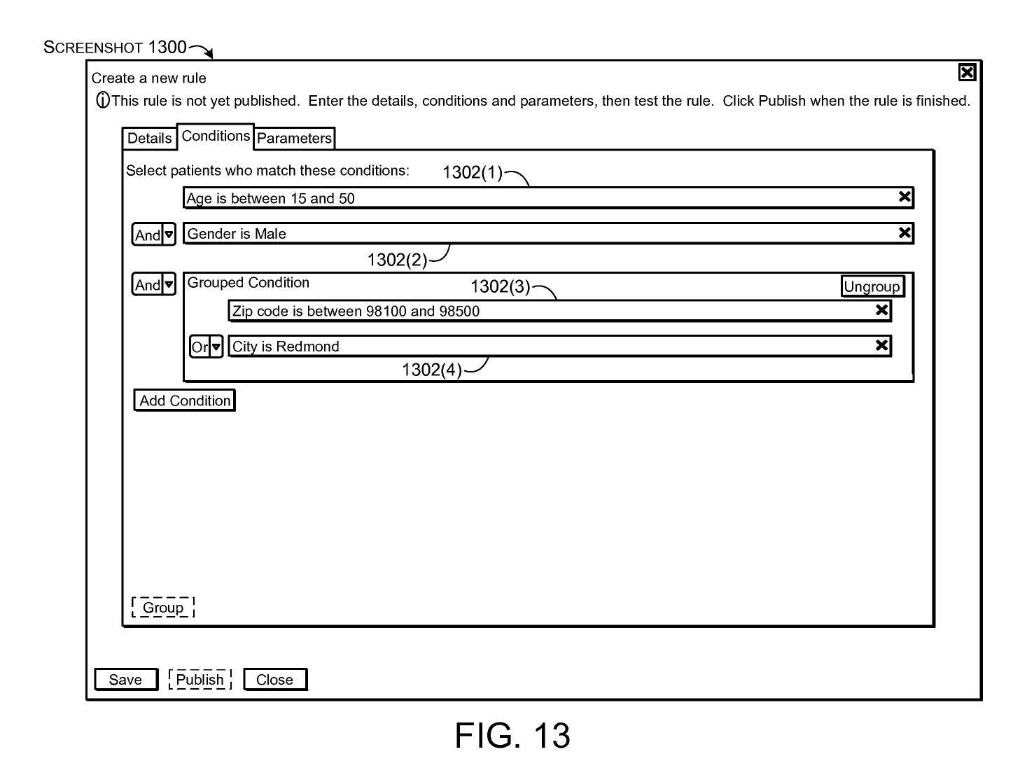

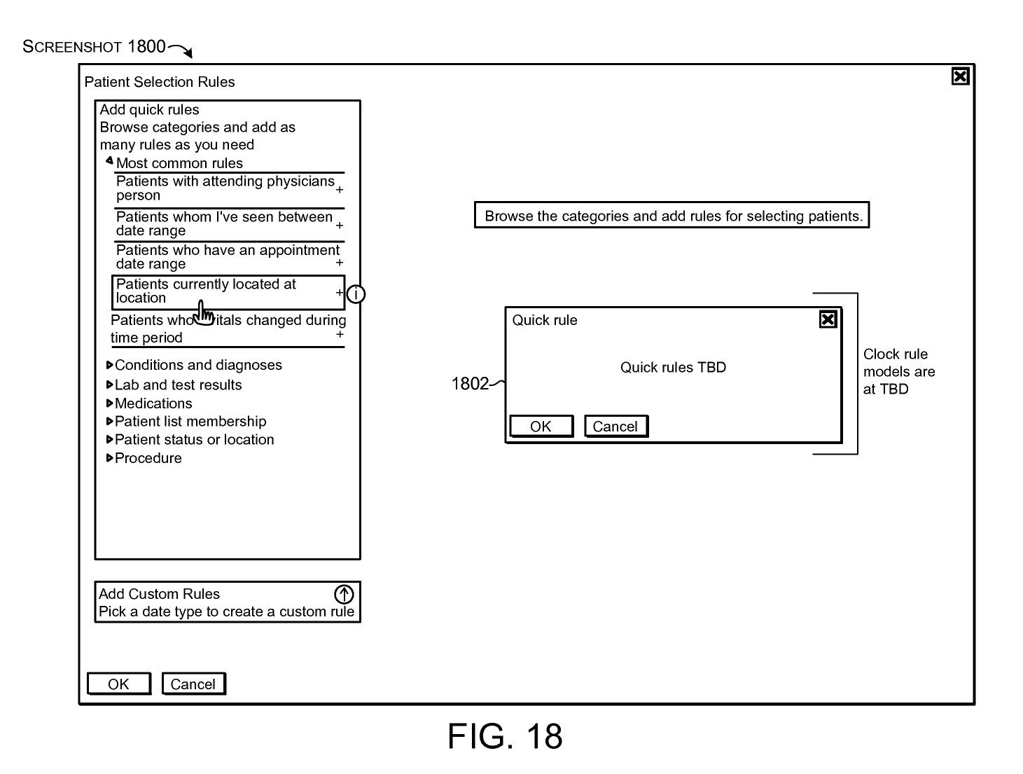

FIGS. 5-12 collectively illustrate user interface screenshots that can be generated by the HCRM platform introduced above. FIGS. 5-7 can be examples of the user interface encountered by the application developer 110(1) introduced in FIG. 1. FIGS. 8-12 can be examples of the user interface encountered by the IT manager 110(2) introduced in FIG. 1. FIGS. 13-17 can be examples of the user interface encountered by the analyst 110(3) introduced in FIG. 1. FIGS. 18-20 can be examples of the user interface encountered by the clinician 110(4) introduced in FIG. 1. Of course these user interface screenshots are only examples of how the underlying functionality can be surfaced by the HCRM platform. Further, other users besides those mentioned here can utilize the user interfaces.

FIG. 5 shows a screenshot 500 of one implementation of a HCRM management console. In this case, the HCRM management console enables entity management. All entities in a given installation of the HCRM platform are listed in the entity listing region 502. Entities can be grouped by namespaces such as HCRM.Common, HCRM.NW, HCRM.DICOM, etc. Some implementations of the HCRM platform may ship some entity definitions out-of-box for use by out-of-box applications that are shipped with the platform. Application developers can create new entities for use in their application in an entity registry region 504. Recall that each application developer may define his/her own namespace for his/her custom entities. This can be accomplished via the entity registry region 504.

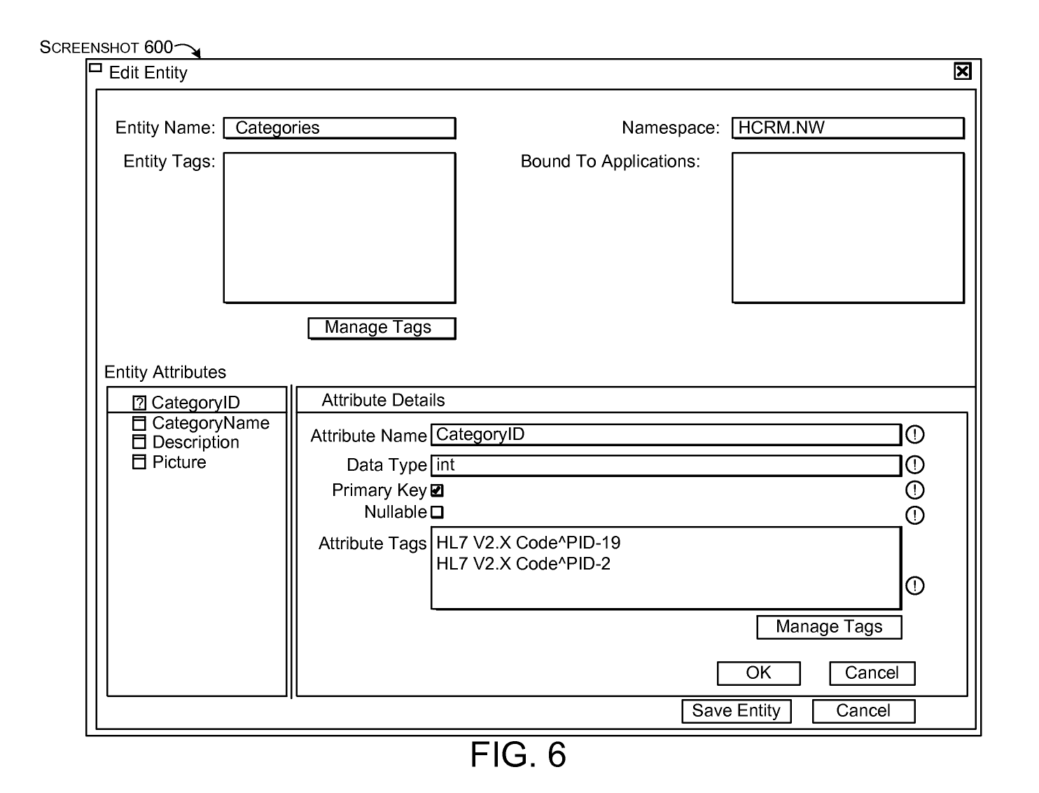

FIG. 6 shows another screenshot 600 where the application developer can create custom entities. Screenshot 600 allows the application developer to edit the entity. For instance, the application developer can choose name of the entity, namespace, attributes (or columns) of the entity, type of the attribute (integer, string, datetime) and whether it is a primary key attribute, and specify semantic (attribute) tags that identify what the attribute is.

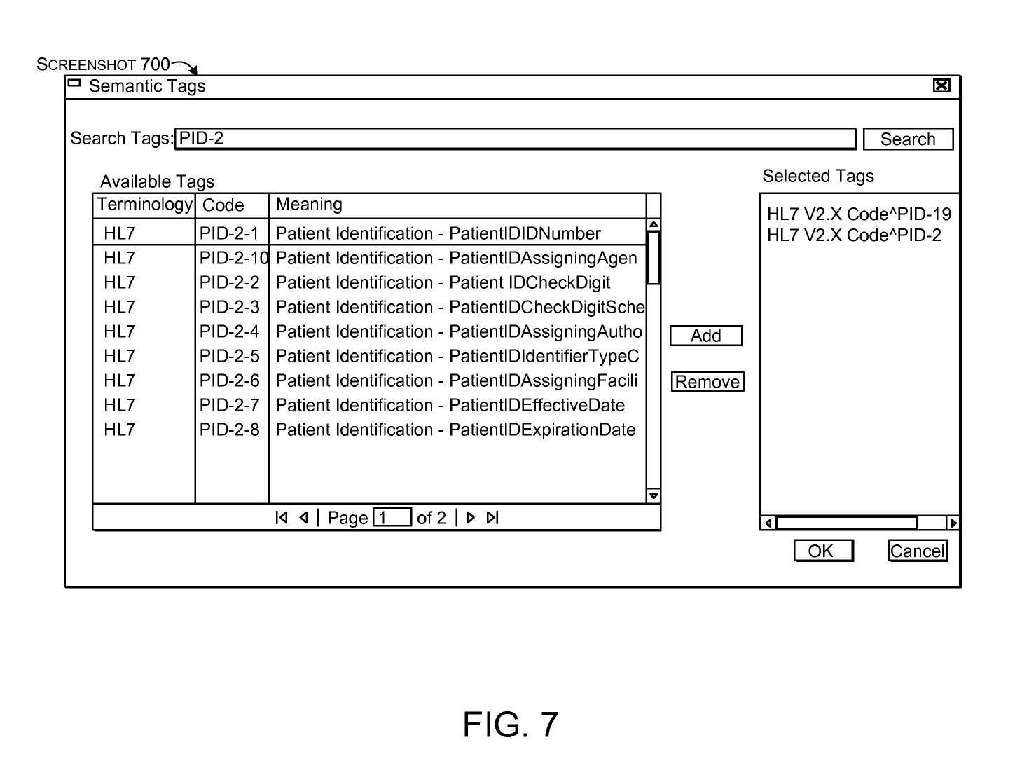

FIG. 7 shows a follow-up screenshot 700 that can allow the application developer to search semantic tags from available terminologies and select the semantic tags that describe (and potentially best describe) the attribute (column) of the entity. Though not shown, in some implementations, the application developer can also create custom semantic tags.

FIG. 8 shows another screenshot 800 that allows the selected entity to be utilized with the application. Stated another way, after an application developer has created an entity, he/she can create an application and use the entity in the application code.

The custom entities can then be installed with the application at the health care organization. For instance, as part of installing the new application, the custom entities of the data manifest are introduced into the system where the application is installed (e.g., the entities from the data manifest are sent to the entity registry). The person deploying the application then “binds” the custom entity to underlying patient data that is available at that particular site (health care organization). In the example provided above relative to FIG. 1, this person is the IT manager 110(2). In some configurations, binding the entity can be thought of as equivalent to specifying a SQL query that will retrieve the patient data for the entity. Note, that this procedure is utilized either when the application developer wants to test his/her application by deploying it on an existing HCRM platform or the application developer has released an application and the IT manager or other similar person is deploying the application at a health care organization that has the HCRM platform already installed.

In the illustrated example, someone created an entity called “BindingTest” under namespace “HCRM.NW” that is shown on the left hand pane (e.g., the entity listing region 502). The user interface (represented by screenshot 800) offers features to help with the binding. In the “Assisted Mode”, the user interface can show every attribute (same as property or column) in the entity (in example above, these are ID, F1, FirstName, LastName) and allow the user to select the underlying database column from a table to which the attribute will be bound. These possible matches can be based on semantic tags. That is, the application developer who created the entity also specified semantic tags for describing every attribute of the entity. When the HCRM platform aggregates data from various systems in a health care organization, the platform tags the data elements. During binding, the HCRM platform can match what the application developer intended with what is available at the health care organization by comparing the semantic tags. As a result of this “assisted binding”, the HCRM platform can generate a SQL query indicated generally at 802. There is also a manual mode where someone (such as the IT manager) can choose to write the SQL query manually that defines how to obtain patient data for the entity from the underlying data store (e.g., patient data). The actual patient data in the data store could be different at each health care organization where the HCRM platform is installed.

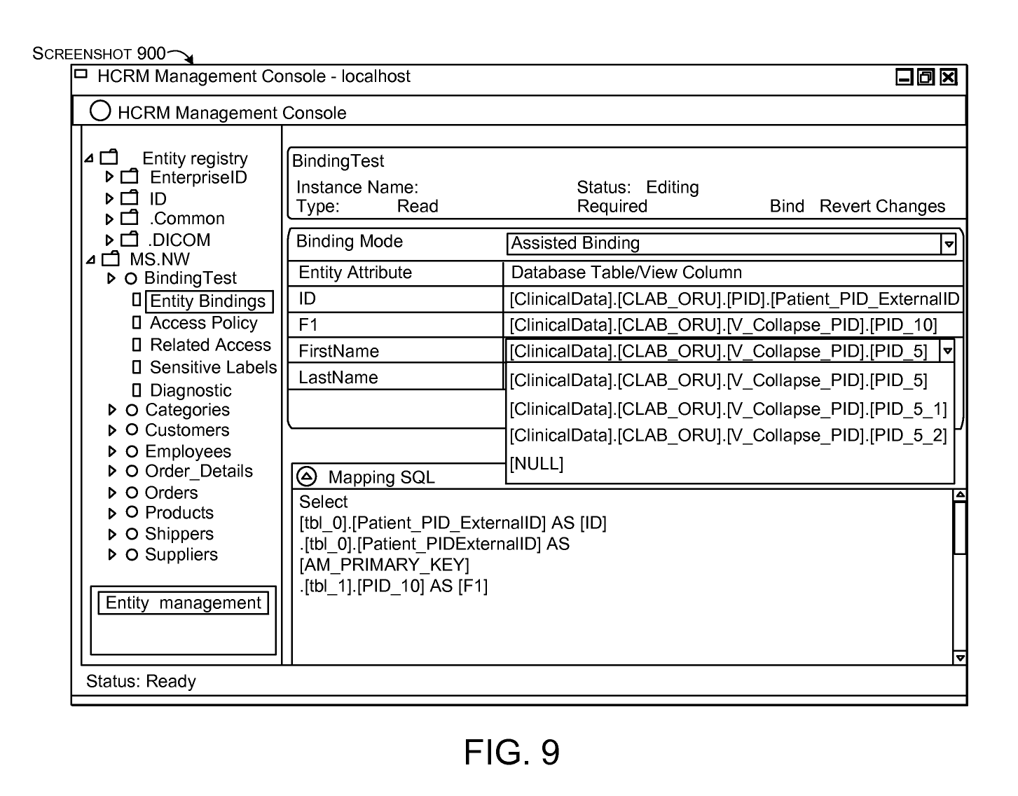

FIG. 9 is a screenshot 900 that relates to the assisted binding case. This screenshot shows how the HCRM platform can allow selecting columns from underlying database tables based on whichever tables provide a good match (and potentially the best match) for binding to the entity-attribute. In this example, the screenshot 900 indicates that FirstName can be obtained from database schema ClinicalData, database CLAB_ORU, table (or view) V_COLLAPSE_PID, column PID_{—}5 or column PID_{—}5_{—}1 or column PID_{—}5_{—}2 because each of these columns contain a tag that indicates that it has something to do with the patient's name.

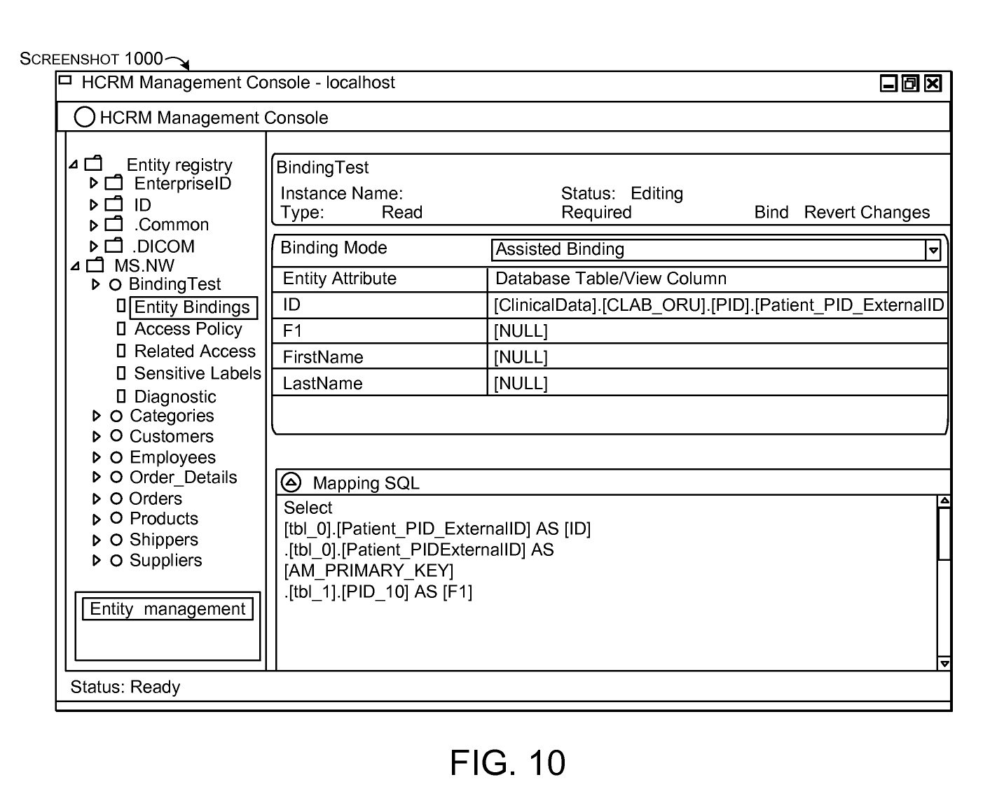

FIG. 10 shows another screenshot 1000 of the user interface after the user makes the selection from the presented tags. The HCRM platform then updates the query that is generated to bind the entity.

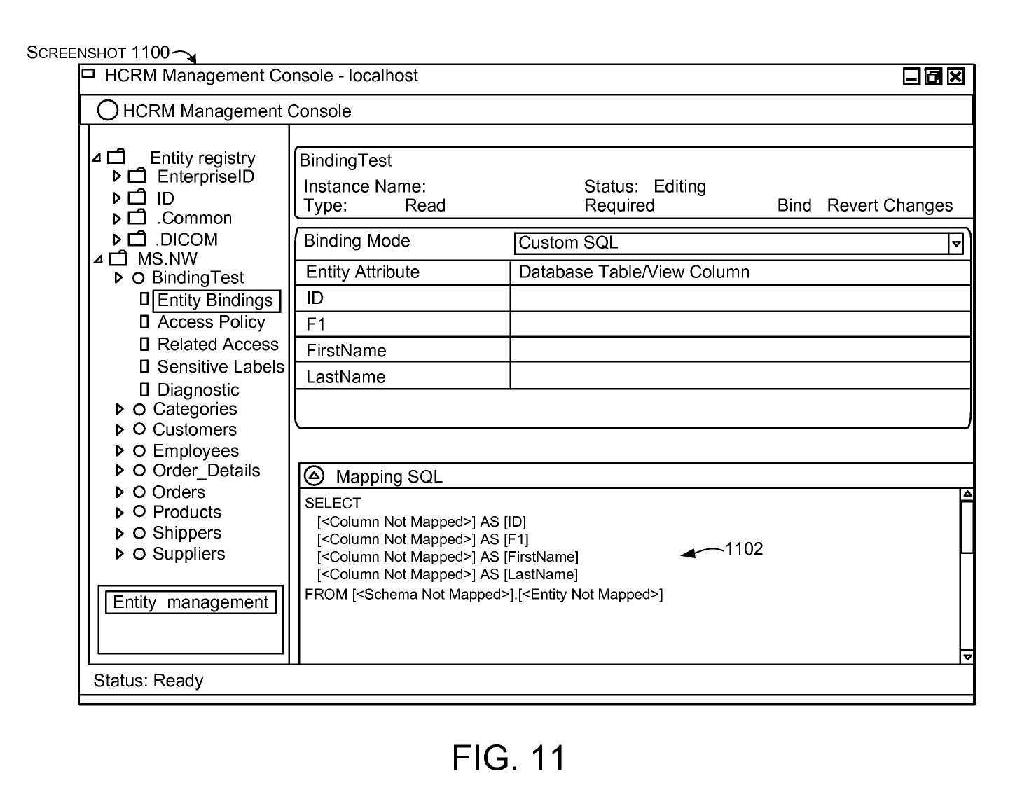

FIG. 11 shows another screenshot 1100. This screenshot is based upon the use of BindingMode=CustomSQL. In this scenario, the user (e.g., IT manager) indicates that he/she wants to customize the query which is used to obtain data for the entity. At 1102, this case presents a default SQL query template that specifies which column (ID, F1, FirstName, LastName) is bound for the entity.

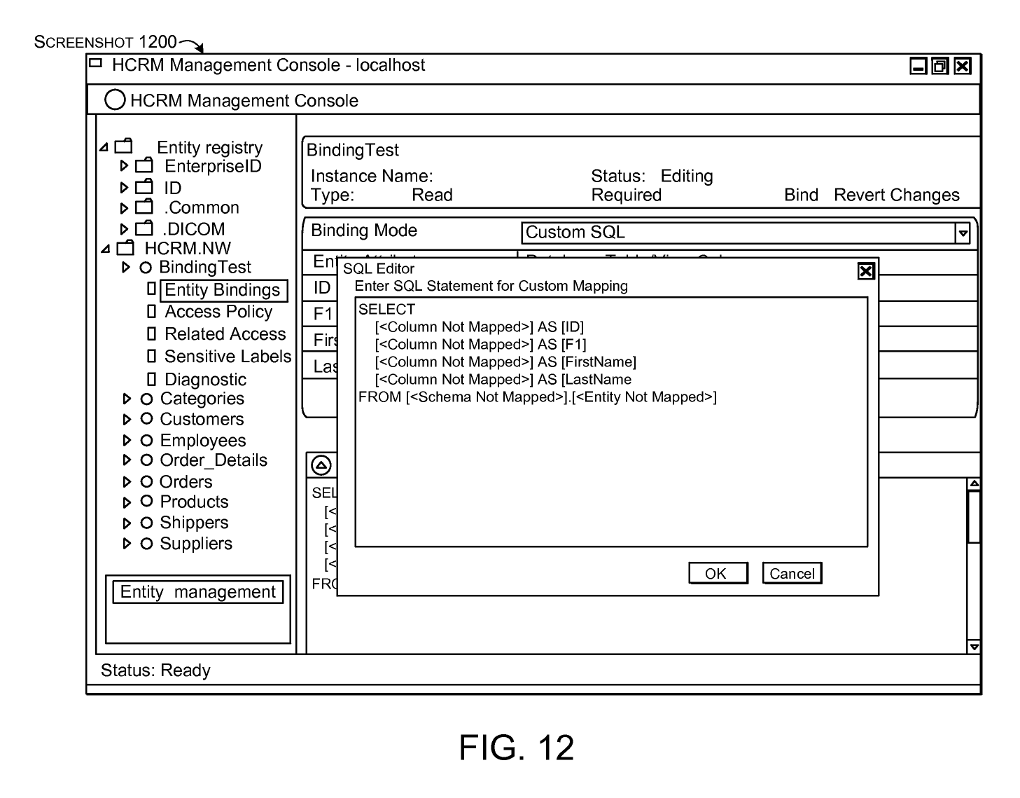

FIG. 12 shows a screenshot 1200 where the HCRM platform provides a text editor for a user (e.g., the IT manager) to provide the SQL query for binding (or mapping) the entity to the underlying data store (e.g., patient data). After all entities utilized/required by an application are bound to underlying data, the application is ready to be used at the health care organization where the application is installed.

FIG. 13 shows a screenshot 1300 that allows a user, such as the analyst 110(3), to define logic for a rule. Boxes 1302(1)-1302(4) represent conditions based on entity attributes. This screen also illustrates the ability to group for the purposes of setting the order of operations for evaluation of the logic (i.e. A And B And [C Or D]).

As used above, a ‘rule’ can be based on a root entity and can be of arbitrary complexity. The rule can be defined as a collection of rule predicates that has a custom internal XML representation. In some implementations, rule queries can be characterized in two ways; quick rules and custom rules. The quick rules can be provided by a rules subsystem. Custom rules and list membership rules can be created using a population management user interface (UI). In some implementations, regardless of whether the rules are quick rules or custom rules, all rule queries can have the same form:

SELECT <Primary Key Columns> FROM <Root Entity> WHERE
<Rule Predicates>

The <Primary Key Columns> are the primary key columns of <Root Entity>. The <Root Entity> is the name of an app view (such as Patient, Visit, etc.). The <Rule Predicates> are one or more Boolean SQL expressions that limit the rows returned from <Root Entity> (such as Patient.Sex=‘F’ or Visit.AdmitDate BETWEEN @StartDate AND @EndDate). These can be arbitrarily complex expressions, as long as they evaluate to a Boolean and can fit into the WHERE clause. Other SQL constructs may be used if needed (such as GROUP BY, HAVING, aggregate functions). Joins are not required because each entity directly or indirectly related to <Root Entity> has a foreign key to <Root Entity>. In some cases, the rule query is composable as a sub-query (no common table expressions (CTEs)).

In some implementations, quick rules provided by the rules subsystem have arbitrarily complex <Rule Predicates>. Custom rules defined in the population management UI can have a single <Rule Predicate> of the form:

```
  • <Entity>.<Attribute> <Operator> <Value>
where
  • <Entity> is the name of a virtual schema entity (App View)
      <Entity> has a foreign key to the <Root Entity>
  • <Attribute> is an attribute of <Entity>
  • <Operator> is a SQL operator such as =, !=, <, >, <=, >=, LIKE,
      CONTAINS, IN, NOT IN
  • <Value> is either:
      • A literal value such as a string, date/time, integer, floating
          point number
      • A value set, which is a SELECT statement enclosed in
          parentheses:
          • SELECT Value FROM <Value Set Table> WHERE
              ValueSetID = <Value Set ID>
          • Where
              • <Value Set Table> is a writable app view defined in
                  the virtual schema that holds value sets. This table
                  has two columns: Value and ValueSetID
              • <Value Set ID> is the unique identifier (GUID) for
                  the value set.
      • In some implementations, in order to prevent SQL injection
          attacks, values obtained from user input are passed as SQL
          parameters.
```

List membership rules are the same as list queries. The list queries are SQL SELECT statements of the form:

```
SELECT <List Entity>.<PK> FROM <List Entity>
WHERE <List Entity>.<PK> IN (<Rule Query>)
    {AND|OR} <List Entity>.<PK> IN (<Rule Query>)
  • <Rule Query> is a rule query, defined above
  • <List Entity> is the listed virtual schema entity (App View)
  • <PK> is the primary key column of <List Entity>
```

This form works if there is a single primary key column, such as Common.Patient.PatientID. Entities with multiple primary key columns could utilize a more complex form using common table expressions and left outer joins:

WITH Rule1 AS (<Rule Query>),
Rule2 AS (<Rule Query>),
SELECT <PKs> FROM <List Entity>
LEFT OUTER JOIN Rule1 ON Rule1.<PK1> = <List Entity>.<PK1> ...
LEFT OUTER JOIN Rule2 ON ...
...
WHERE Rule1.<PK1> IS NOT NULL
{AND|OR} Rule2.<PK1> IS NOT NULL
...

The following example can help to illustrate the above mentioned points.

```
SELECT DISTINCT Patient.PatientID
FROM Patient
WHERE Patient.PatientID IN (
    SELECT Diagnosis.PatientID
    FROM Diagnosis
    WHERE Diagnosis.DxDescription = ‘Fever’)
AND Patient.PatientID IN (
    SELECT Patient.PatientID
    FROM Patient
    WHERE Patient.Sex = ‘M’);
```

List queries are used to construct list membership rules. List membership rules are treated in the same way as rule queries in the WHERE clause:

```
    <List Entity>.<PK> IN (<List Query>)
∘ Or
    <List Entity>.<PK> NOT IN (<List Query>)
```

Alternatives implementations can include using SQL set operations like INTERSECT and UNION to compose list queries out of rule queries. Alternatively, rules can be combined into a single SELECT statement, but rule queries that have non-trivial forms (GROUP BY, aggregates, sub-queries) could be difficult to combine.

In some implementations there are two types of list view queries; base list view query and grid list view query. A base list view query is a SQL SELECT statement with multiple columns that may be from joined entities. If the joined entities have a one to many relationship with the <List Entity> then there may be multiple row sets per <List Entity> instance. Base list view queries are used by some subsystems to build reports and graphs.

A grid list view query is a SQL SELECT statement with multiple columns that may be from joined entities, just like a base list view query. However, grid list view queries may have scalar-valued sub-queries in the SELECT clause to limit the returned rows to one per <List Entity> instance.

List view queries are SQL SELECT statements of the form:

```
SELECT <List View Columns> FROM <List Entity>
<Related Entity Joins>
WHERE <List Entity>.<PK> IN (<Rule Query>)
  {AND|OR} <List Entity>.<PK> IN (<Rule Query>)
...
ORDER BY <List View Column Order>
  ∘ <List View Columns> are one or more column expressions, which
      may include scalar-valued sub-queries (sub-queries that return a
      scalar value).
  ∘ <List Entity> is the name of an entity (App View) in the virtual
      schema such as patient, visit, etc.
  ∘ <Related Entity Joins> are zero or more LEFT INNER JOIN
      clauses utilized if any of <List View Columns> comes from an
      entity besides <List Entity>
  ∘ <PK> is the primary key column of <List Entity>
  ∘ <Rule Query> is defined above
  ∘ <List View Column Order> defines the row ordering for the result
      set. <List View Column Order> and the ORDER BY clause can
      be omitted if this is a base list view query.
```

The following simple example can further aid in understanding the above mentioned base list view query:

```
    SELECT DISTINCT
        Patient.PatientID,
        Patient.MRN,
        Patient.LName,
        Patient.FName,
        Patient.DOB,
        Visit.VisitID,
        Visit.AdmitDateTime,
        Visit.AttendingMDName
    FROM Patient
    JOIN Visit on Visit.PatientID = Patient.PatientID
    -- Rule Composition:
    WHERE Patient.PatientID IN (
        SELECT Patient.PatientID FROM Patient
        WHERE (
            SELECT TOP 1 DischargeDateTime
            FROM Visit
            WHERE Visit.PatientID = Patient.PatientID
            AND AdmitDateTime < SYSDATETIME( )
ORDER BY AdmitDateTime DESC) IS NULL)
```

The following simple example can further aid in understanding the above mentioned Grid List View Query:

```
SELECT DISTINCT
    Patient.MRN,
    Patient.LName,
    Patient.FName,
    Patient.DOB,
    -- Derived Field:
    (SELECT TOP 1 Visit.AdmitDateTime
        FROM Visit
        WHERE Visit.PatientID = Patient.PatientID
        ORDER BY AdmitDateTime DESC) AS AdmitDateTime,
    -- Derived Field:
    (SELECT TOP 1 Visit.AttendingMDName
        FROM Visit
        WHERE Visit.PatientID = Patient.PatientID
        ORDER BY AdmitDateTime DESC) AS AttendingMDName
FROM Patient
-- Rule Composition:
WHERE Patient.PatientID IN (
    SELECT Patient.PatientID FROM Patient
    WHERE (
        SELECT TOP 1 DischargeDateTime
        FROM Visit
        WHERE Visit.PatientID = Patient.PatientID
        AND AdmitDateTime < SYSDATETIME( )
        ORDER BY AdmitDateTime DESC) IS NULL)
```

Additional filters can be added to the list view query in the same manner as rules (filters can be thought of as rules attached to a list view).

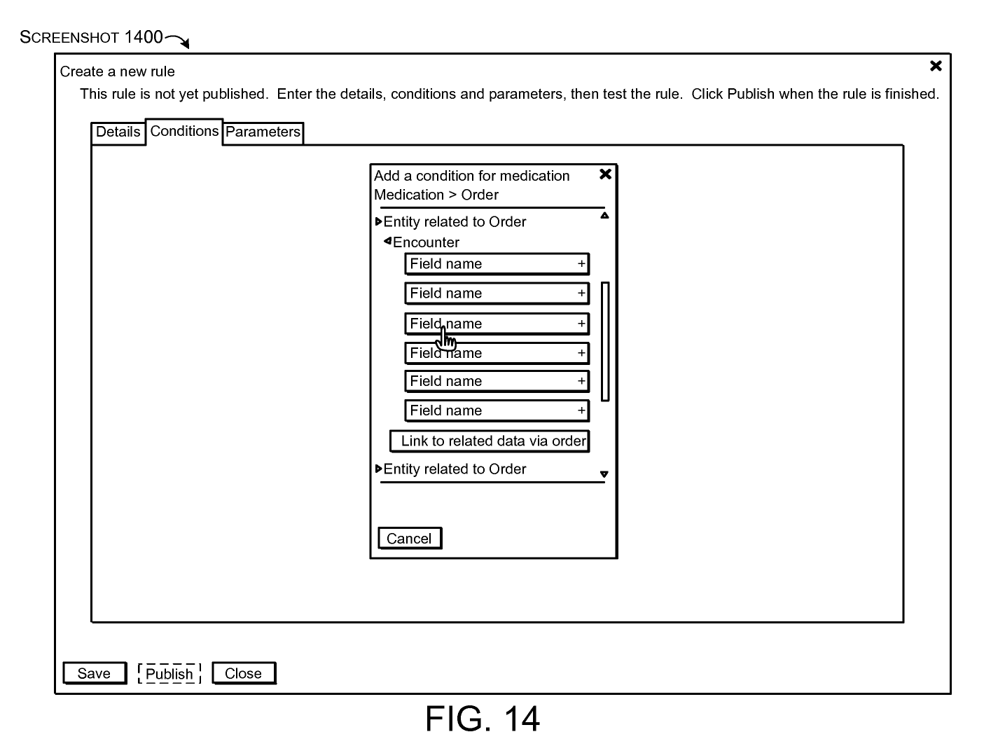

FIG. 14 shows a screenshot 1400 that offers the ability to add conditions to a rule. In this case, the analyst will navigate through the entity model defined by the IT manager 110(2) to select the attribute on which to base the condition. The path the analyst chooses to navigate through the model defines the path utilized by the HCRM platform to navigate when evaluating the rule. For example, if the analyst navigates from patient to medication, that implies the rule should be based around any medication related to the patient. However, if the analyst navigates from patient to encounter (e.g., visit) to medication, that implies that the analyst cares about medications in the context of the encounter during which the medication was received/prescribed. Thus, there may be additional conditions added on the encounter that also restrict the medications (such as only considering medications from a visit at a particular facility).

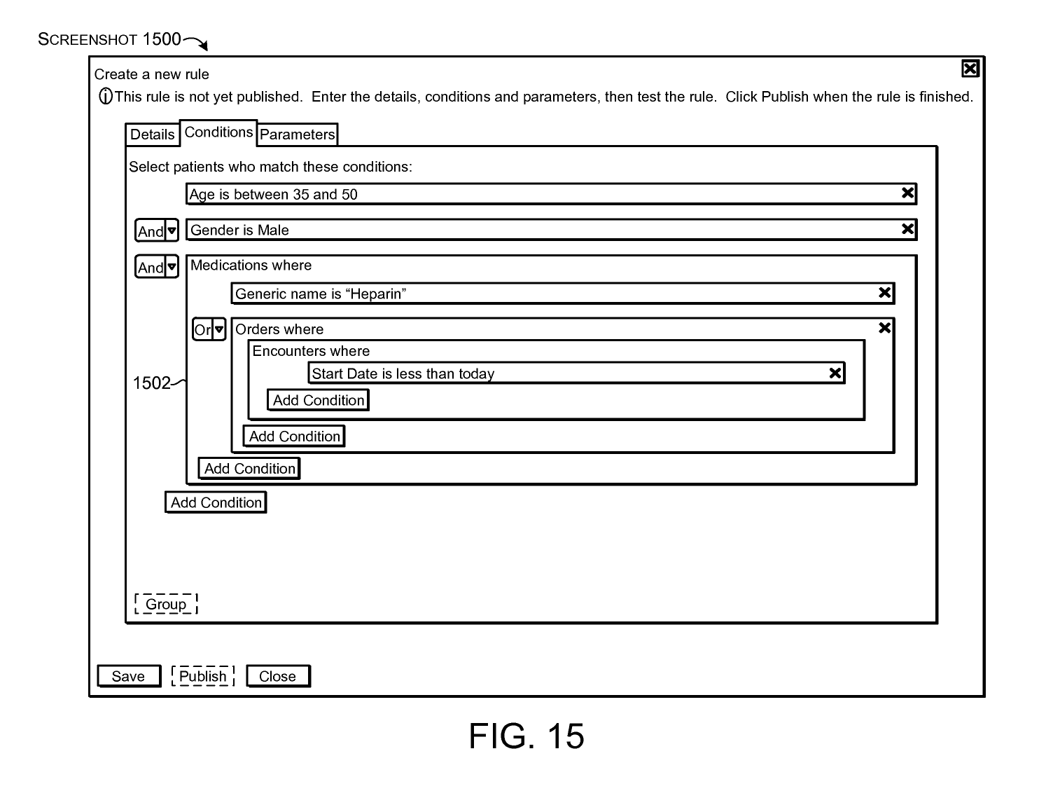

FIG. 15 shows a screenshot 1500 that shows logic represented with multiple entities where those entities have conditions based on other entities (e.g., nesting of box 1502).

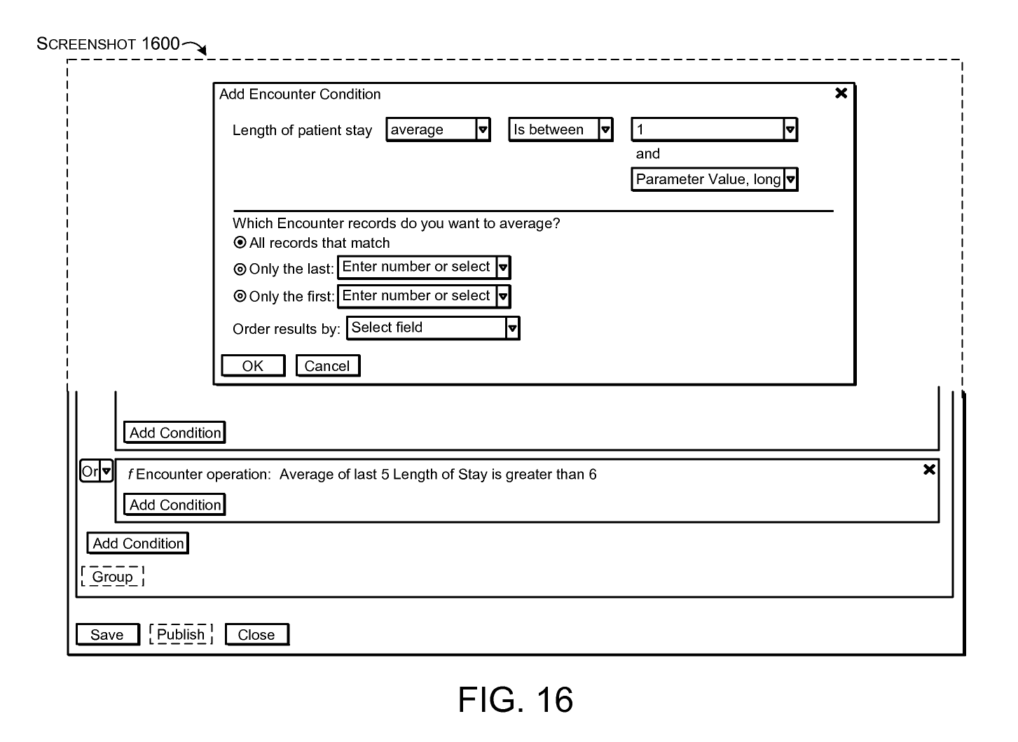

FIG. 16 shows a screenshot 1600 that enables creating rules based on aggregations of the instances of an entity's attribute or a subset of those instances. The example above bases a condition on the average length of stay for a patient's visits. The HCRM also allows the user to also limit this to include, for example, only the last 5 visits by discharge date (another attribute of the visit entity).

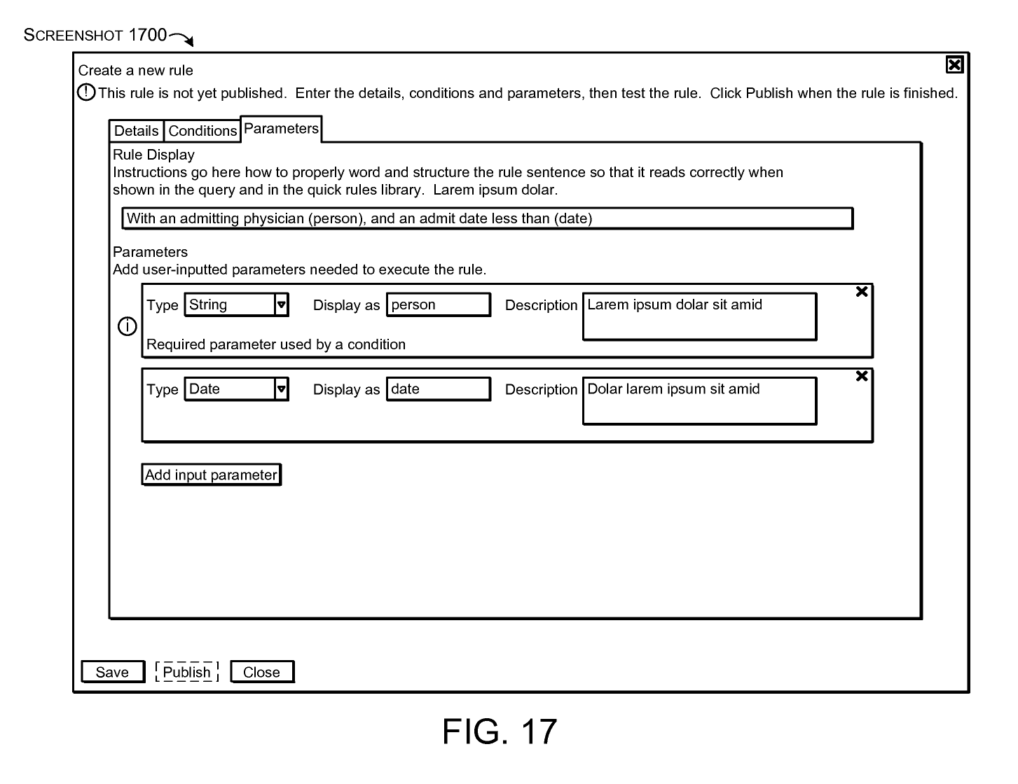

FIG. 17 shows screenshot 1700 where rules may have parameters specified by the analyst to be filled in by the end user (e.g., clinician) at runtime. The value provided by the end user will be substituted into the rule when it is evaluated. For example on the previous screenshot the upper bound for the between condition would be provided by the end user.

FIG. 18 is a UI screenshot 1800 used by an end user (e.g. clinician) to combine rules to create a list of patients. When a rule is added, if it has parameters, a dialog box 1802 can be presented which allows the user to provide those parameters.

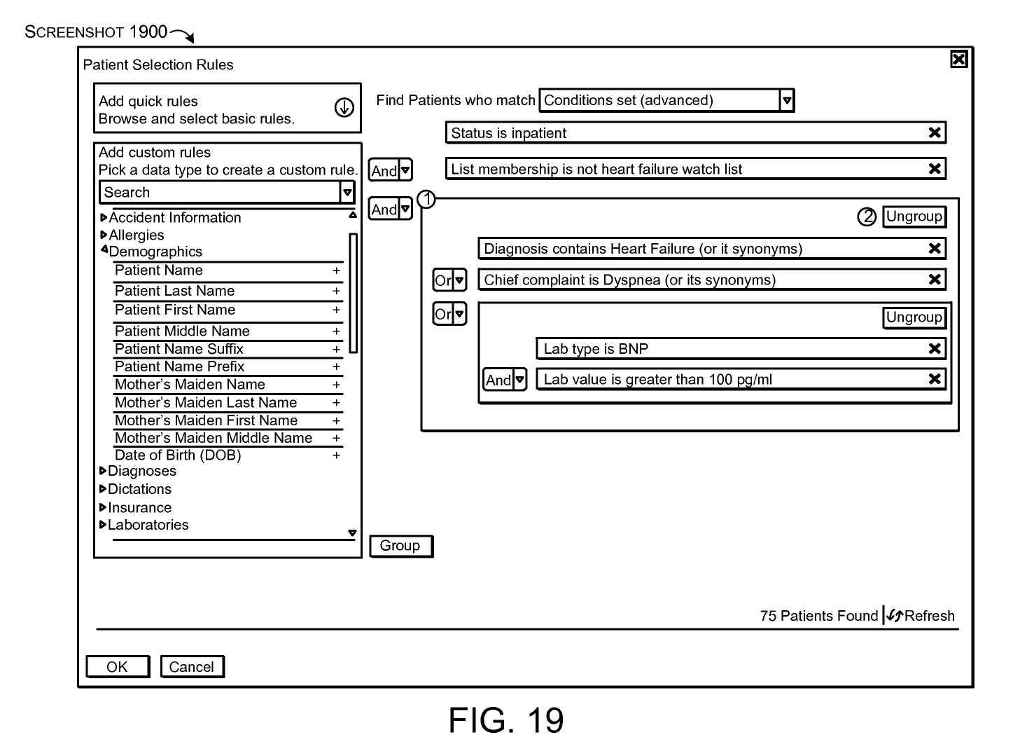

FIG. 19 is a screenshot 1900 that offers additional features to advanced end users. In this case advanced users may also create patient lists based directly off of the attributes of entities in the virtual schema.

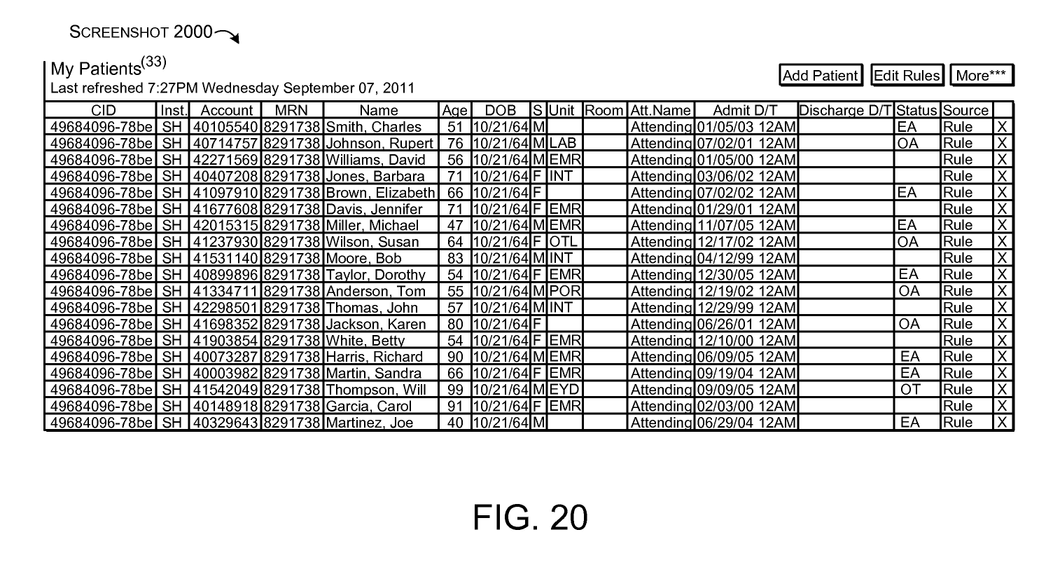

FIG. 20 shows a screenshot 2000 generated once an end user is happy with the rules for their list. The end user can then run the rule query. Screenshot 2000 shows the list of patients who match the criteria that were defined.

### System Example

FIG. 21 shows an example of a system 2100 that can implement the patient data abstraction framework discussed above. For purposes of explanation, system 2100 is explained in the context of the application developer 110(1), IT manager 110(2), analyst 110(3), and clinician 110(4) as introduced above. Also carried over from the above discussion are the HCRM platform 106(1), the entity registry 116, the rules library 120, the functions list 122 and the patient data 108(1)-108(N). System 2100 also includes five computers 2102(1)-2102(5) that can communicate over a network 2104. (The number of computers is selected for purposes of explanation and is not critical to the system or the inventive concepts). The HCRM platform includes a data manifest designer 2106, a data manifest deployer 2108, a function builder 2110, and a declarative algorithm builder 2112. The computers can also include or interact with a processor 2114 and storage 2116 (illustrated relative to computer 2102(5)) and/or external storage 2118 (illustrated relative to computer 2102(4)).

The data manifest designer 2106 (also called virtual schema designer) is a visual tool that enables the application developer 110(1) to create the application's data model (virtual schema). The data manifest designer can be used to visually create and modify the virtual schema data objects, properties, associations, etc. The data manifest designer also allows the application developer to automatically generate their data model using entities available in the entity registry 116. The auto-generated objects can then be further modified manually to suit the application's needs.

The data manifest deployer 2108 can be used to deploy the application's data manifest and create mappings and other artifacts utilized by the HCRM platform 106(1) at runtime to execute queries on the virtual schema objects. In short, the data manifest deployer can create a metadata layer for the deployed application instance.

The function builder 2110 allows the IT manager 110(2) to define a function. The IT manager or similar user tends to understand the virtual schema data model and understand some basic programming and SQL concepts. The IT manager can also work with clinician 110(4) to understand the clinician's needs and then use the function builder to define the underlying functions. The function builder can store functions in the functions list 122.

The declarative algorithm builder 2112 can use (re-use) functions from the functions list 122 to support the clinician 110(4) in providing patient care. Similarly, the functions can be used for user notification, alerting, and analytics. Recall that functions can be generated from multiple rules, so in some cases, the declarative algorithm builder may use any combination of rules from the rules library 120 and/or functions from the function list to aid the user in searching the patient data in a user-friendly and effective manner.

System 2100 can represent a web-based implementation where the HCRM functionality is provided on computer 2105(5) that is remote from the user's computers 2102(1)-2102(4). The results of the functionality can then be presented to the users on computers 2102(1)-2102(4). Alternatively, system 2100 can be a distributed system where some of the functionality is provided locally and some of the functionality is provided remotely. For instance, the data manifest designer 2106 could run on the application developer's computer 2102(1) while the other components ran on computer 2102(5). In still another configuration, a fully functioning HCRM platform with the data manifest designer 2106, data manifest deployer 2108, function builder 2110, and declarative algorithm builder 2112 could operate on each user's computer. These components could then access and update a central entity registry 116, rules library 120 and functions list 122.

The term “computer” or “computing device” as used herein can mean any type of device that has some amount of processing capability and/or storage capability. Processing capability can be provided by one or more processors (such as processor 2114) that can execute data in the form of computer-readable instructions to provide a functionality. Data, such as computer-readable instructions, can be stored on storage 2116 or 2118. The storage can include any one or more of volatile or non-volatile memory, hard drives, flash storage devices, and/or optical storage devices (e.g., CDs, DVDs etc.), among others. As used herein, the term “computer-readable media” can include transitory and non-transitory computer-readable instructions. In contrast, the term “computer-readable storage media” excludes transitory instances. Computer-readable storage media includes “computer-readable storage devices”. Examples of computer-readable storage devices include volatile storage media, such as RAM, and non-volatile storage media, such as hard drives, optical discs, and flash memory, among others.

Examples of computing devices can include traditional computing devices, such as personal computers, cell phones, smart phones, personal digital assistants, or any of a myriad of ever-evolving or yet to be developed types of computing devices. Further, aspects of system 2100 can be manifest on a single computing device or distributed over multiple computing devices.

### First Method Example

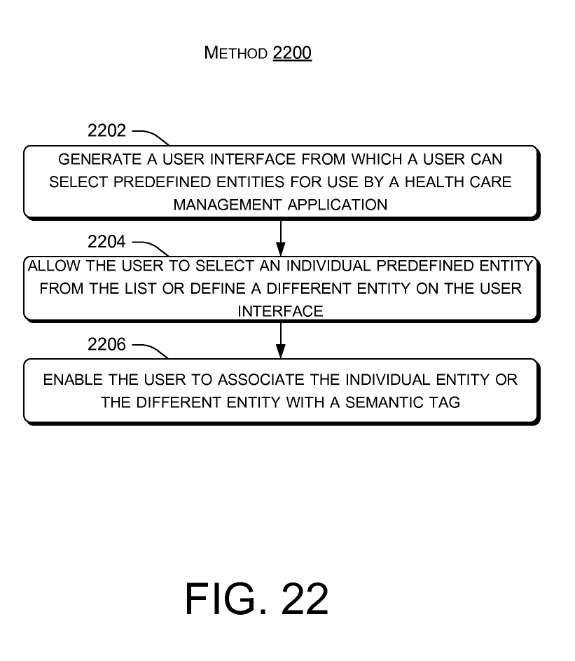

FIG. 22 illustrates a flowchart of a method or technique 2200 that is consistent with at least some implementations of the present concepts.

In this case at 2202, the method can generate a user interface from which a user can select predefined entities for use by a health care management application. The entities serve to abstract the health care management application from underlying patient data.

At 2204, the method can allow the user to select an individual predefined entity from the list or define a different entity on the user interface.

At 2206, the method can enable the user to associate the individual entity or the different entity with a semantic tag.

### Second Method Example

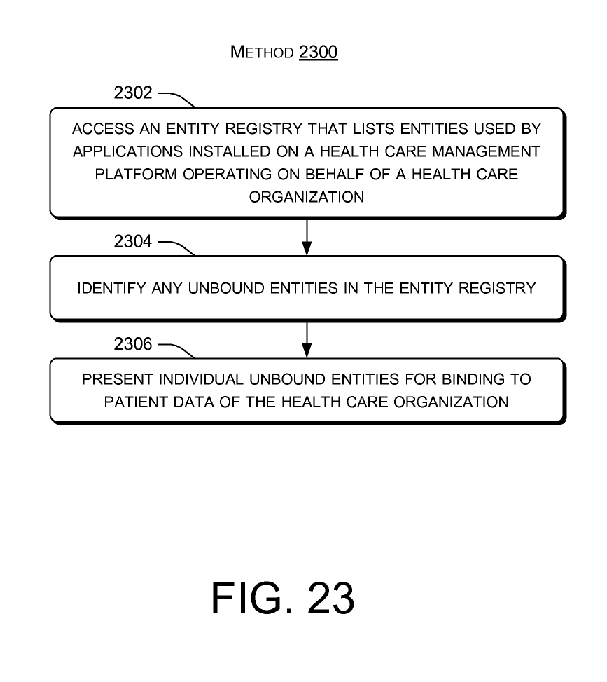

FIG. 23 illustrates a flowchart of a method or technique 2300 that is consistent with at least some implementations of the present concepts.

In this case at 2302, the method can access an entity registry that lists entities used by applications installed on a health care management platform operating on behalf of a health care organization.

At 2304, the method can identify any unbound entities in the entity registry.

At 2306, the method can present individual unbound entities for binding to patient data of the health care organization.

### Third Method Example

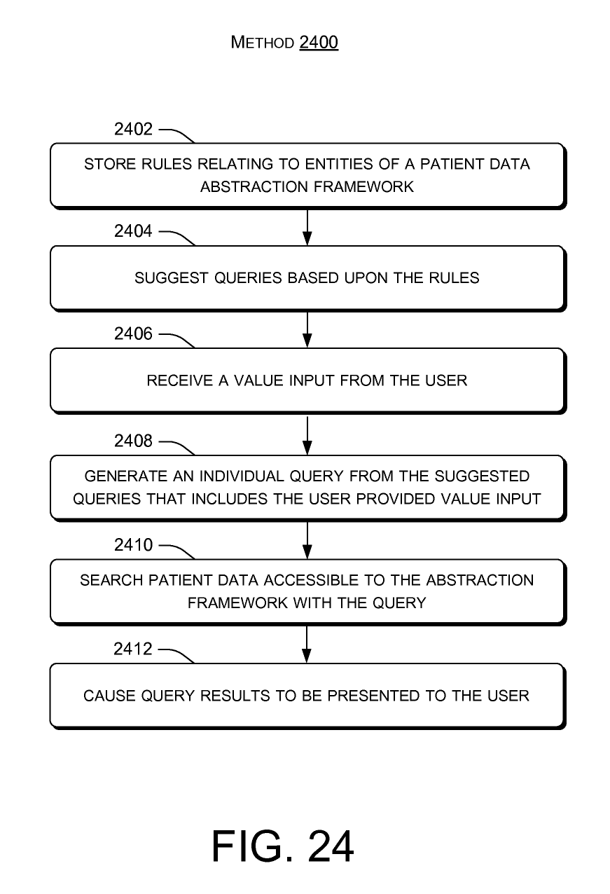

FIG. 24 illustrates a flowchart of a method or technique 2400 that is consistent with at least some implementations of the present concepts.

In this case at 2402 the method can store rules relating to entities of a patient data abstraction framework.

At 2404 the method can suggest queries based upon the rules.

At 2406 the method can receive a value input from the user.

At 2408 the method can generate an individual query from the suggested queries that includes the user provided value input.

At 2410 the method can search patient data accessible to the abstraction framework with the query.

At 2412 the method can cause query results to be presented to the user.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although techniques, methods, devices, systems, etc., pertaining to a patient data abstraction framework are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that, when executed by a computing device, cause the computing device to perform acts, comprising:
generating a user interface from which a user can select predefined entities for use by a health care management application, wherein the entities abstract the health care management application from underlying patient data;
allowing the user to select an individual predefined entity from the list or define a different entity on the user interface; and,
enabling the user to associate the individual entity or the different entity with a semantic tag.

2. The computer-readable storage medium of claim 1, wherein the generating comprises presenting categories of the predefined entities on the user interface.

3. The computer-readable storage medium of claim 1, wherein the generating comprises presenting attributes of the predefined entities on the user interface.

4. The computer-readable storage medium of claim 1, wherein the generating comprises presenting a definition of the predefined entities on the user interface.

5. The computer-readable storage medium of claim 1, wherein the allowing comprises allowing the user to define attributes for the different entity.

6. The computer-readable storage medium of claim 1, further comprising providing a dictionary of semantic tags on the graphical user interface.

7. The computer-readable storage medium of claim 1, further comprising receiving the health care management application and an associated data manifest that includes the semantically tagged individual entity or the different entity.

8. The computer-readable storage medium of claim 7, further comprising retrieving the semantically tagged individual entity or the different entity from the data manifest and checking whether the semantically tagged individual entity or the different entity already exists in an entity registry and in an instance where the semantically tagged individual entity or the different entity from the data manifest does not already exist in the entity registry adding the semantically tagged individual entity or the different entity from the data manifest to the entity registry.

9. The computer-readable storage medium of claim 7, further comprising retrieving the semantically tagged individual entity or different entity from the data manifest and checking whether the semantically tagged individual entity or different entity already exists in an entity registry and in an instance where the semantically tagged individual entity or different entity from the data manifest does not already exist in the entity registry adding the semantically tagged individual entity or different entity from the data manifest to the entity registry.

10. A method, comprising:
accessing an entity registry that lists entities used by applications installed on a health care management platform operating on behalf of a health care organization;
identifying any unbound entities in the entity registry; and,
presenting individual unbound entities for binding to patient data of the health care organization.

11. The method of claim 10, wherein the presenting comprises automatically suggesting a mapping that binds the individual unbound entities to columns of data tables comprising the patient data.

12. The method of claim 10, wherein the presenting comprises presenting attributes of the individual unbound entities and allowing a user to input a mapping that binds the individual unbound entities to columns of data tables comprising the patient data.

13. At least one computer-readable storage medium having instructions stored thereon that, when executed by a computing device, cause the computing device to perform acts, comprising:
storing rules relating to entities of a patient data abstraction framework;
suggesting queries based upon the rules;
receiving a value input from the user;
generating an individual query from the suggested queries that includes the user provided value input;
searching patient data accessible to the patient data abstraction framework with the query; and,
causing query results to be presented to the user.

14. The computer-readable storage medium of claim 13, wherein the suggesting queries comprises presenting a listing of frequently used rules.

15. The computer-readable storage medium of claim 14, wherein the presenting comprises presenting the frequently used rules organized by categories.

16. The computer-readable storage medium of claim 13, wherein the receiving comprises receiving a parameterized value input.

17. The computer-readable storage medium of claim 13, wherein the suggesting queries comprises presenting categories of frequently used rules.

18. The computer-readable storage medium of claim 13, embodied on a single computing device or distributed over multiple computing devices.

19. The computer-readable storage medium of claim 13, wherein the storing rules comprises generating a graphical user interface upon which a different user can create and publish re-usable units of logic leveraging individual entities and semantically interoperable constructs that serve as a basis for the suggested queries.

20. The computer-readable storage medium of claim 13, wherein the suggesting queries allows the user to consume the rules by providing semantic inputs without the user knowing details of underlying physical or logical layers of the patient data abstraction framework.
